(19) United States
(12) Patent Application Publication
(10) Pub. No.: US 2012/0246899 A1
(43) Pub. Date: Oct. 4, 2012

(54) PROFILE MEASURING APPARATUS, METHOD FOR MEASURING PROFILE, AND METHOD FOR MANUFACTURING STRUCTURE

(76) Inventors: Tomoaki YAMADA, Yokohama -shi (JP); Takashi Tanemura, Zushi-shi (JP)

(21) Appl. No.: 13/435,147

(22) Filed: Mar. 30, 2012

(30) Foreign Application Priority Data
Apr. 1, 2011 (JP) 2011-081751

(51) Int. Cl. G01B 11/25; B23P 6/00; B23P 17/00

(52) U.S. Cl. 29/407.04; 356/610

(57) ABSTRACT

A profile measuring apparatus includes: an irradiating unit which is configured to irradiate the measuring object with light from the light source to form a spotted pattern; a scanner which is configured to relatively scan the surface of the measuring object with the spotted pattern; a light receiver which includes a plurality of light-receiving pixels aligned to detect an image of the spotted pattern generated by the light irradiating the measuring object from a different direction different from an irradiation direction of the light irradiating the measuring object; a changing unit which is configured to change positions, at which signals utilized to detect a position of the image of the spotted pattern are obtained, according to the irradiation direction of the light; and a controller which is configured to calculate positional information of the measuring object based on the signals from the light-receiving pixels.

### CROSS-REFERENCE TO RELATED APPLICATIONS

The present application claims priority from Japanese Patent Application No. 2011-081751, filed on Apr. 1, 2011, the disclosure of which is incorporated herein by reference in its entirety.

### BACKGROUND

1. Field of the Invention

The present invention relates to a profile measuring apparatus, a method for measuring a profile, and a method for manufacturing a structure.

2. Description of the Related Art

As a method for measuring three-dimensional profiles of measuring objects in a noncontact manner, the light-section method is known (for example, see U.S. Pat. No. 6,441,908). In the light-section method, a three-dimensional profile of a measuring object is measured from light-section lines formed in accordance with the sectional shape of the measuring object by irradiating the measuring object with linear light obtained by scanning with a light flux by which a spotted pattern is projected on the measuring object. A profile measuring apparatus such as disclosed in U.S. Pat. No. 6,441,908 includes, for example, a line sensor. The profile measuring apparatus irradiates the scanning spot light onto the line sensor to form an image thereon, and measures three-dimensional profiles of measuring objects.

### SUMMARY

According to an aspect of the present teaching, there is provided a profile measuring apparatus which measures a profile of a measuring object, including:

an irradiating unit which includes a light source and which is configured to irradiate the measuring object with light from the light source to form a spotted pattern;

a scanner which is arranged in an optical path of the light irradiated from the irradiating unit to relatively scan the surface of the measuring object with the spotted pattern;

a light receiver which includes a plurality of light-receiving pixels aligned to detect an image of the spotted pattern generated by the light irradiating the measuring object from a different direction different from an irradiation direction of the light irradiating the measuring object;

a changing unit which is connected to the scanner and the light receiver to a change position, at which a signal of the light receiver utilized to detect a position of the image of the spotted pattern is obtained, according to the irradiation direction of the light; and

a controller which is connected to the light receiver to calculate positional information of the measuring object based on the signal from the light receiver.

### BRIEF DESCRIPTION OF THE DRAWINGS

FIG. 1 is a schematic view showing a construction of a profile measuring apparatus in accordance with the embodiments of the present teaching;

FIGS. 2A and 2B are schematic views showing a construction of an optical probe in accordance with a first embodiment;

FIG. 3 is a block diagram outlining a configuration of the profile measuring apparatus in accordance with the first embodiment;

FIG. 4 shows a scanning image of spot light in accordance with the first embodiment;

FIG. 5 shows an example of ROI selection of a CMOS sensor in accordance with the first embodiment;

FIG. 6 is a schematic view showing a construction of a probe in accordance with a second embodiment;

FIG. 7 is a block diagram outlining a configuration of the profile measuring apparatus in accordance with the second embodiment;

FIGS. 8A and 8B are block diagrams outlining a configuration of a spot light source in accordance with a third embodiment;

FIG. 9 is a block diagram outlining a configuration of a controller and an optical probe in accordance with a fourth embodiment;

FIG. 10 is a timing chart showing an operation of a rolling shutter camera in accordance with the fourth embodiment;

FIG. 11 is an explanatory diagram explaining an example of setting an exposure time in accordance with the fourth embodiment;

FIG. 12 is a block diagram outlining a configuration of a controller and an optical probe in accordance with a fifth embodiment;

FIG. 13 is a block diagram outlining a configuration of a structural object manufacturing system in accordance with a sixth embodiment;

FIG. 14 is a flowchart showing a process flow of the structural object manufacturing system in accordance with the sixth embodiment; and

FIG. 15 is a flowchart showing a profile measuring method in accordance with the present teaching.

### DESCRIPTION OF THE EMBODIMENTS

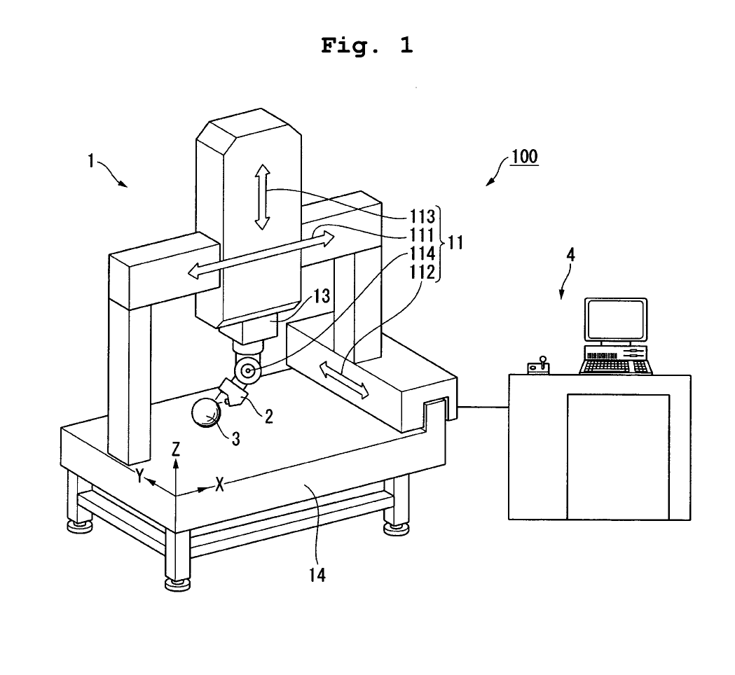

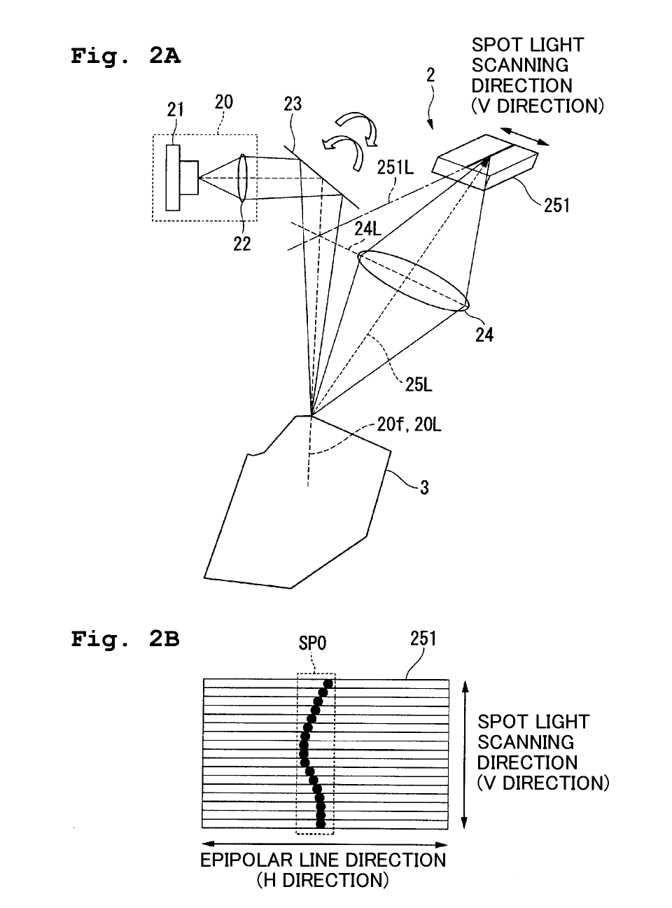

Hereinafter, referring to the accompanying drawings, explanations will be made with respect to a profile measuring apparatus in accordance with the present teaching. FIG. 1 shows a construction of a profile measuring apparatus 100 in accordance with the embodiments of the present teaching. The profile measuring apparatus 100 in accordance with the embodiments is a three-dimensional profile measuring apparatus having a configuration such as shown in FIG. 2A, and utilizing the light-section method to detect a three-dimensional profile of a measuring object 3. The profile measuring apparatus 100 irradiates, onto the surface of the measuring object 3, a light flux to become a spotted pattern when the surface of the measuring object 3 is irradiated, and receives scattered light generated by the light flux irradiating the measuring object 3 from a different angle with the irradiation direction. The spotted pattern (to be referred to as spot light hereinafter) forms a spotted pattern image (to be referred to as a spot light image hereinafter) in a CMOS sensor 251, which detects the position of the spot light image in the CMOS sensor 251. The profile measuring apparatus 100 scans with the light flux to irradiate the surface of the measuring object 3, and detects the position of each spot light image. Then, the profile measuring apparatus 100 calculates the height of the surface of the measuring object 3 from a reference plane by applying the principle of triangulation and the like to the positions of the detected spot light images, and finds a three-dimensional profile of the surface of the measuring object 3. Further, when utilizing the light-section method, the spot light scanning is carried out such that each spotted pattern may scan with a short period in one direction. In this manner, the profile measuring apparatus 100 irradiates a measuring object while scanning with the spot light so that a height distribution of the measuring object along a certain line can be obtained as if a linear pattern is projected on the measuring object. Then, the measuring object is moved such that the light flux of scanning with the short period in one direction in the above manner moves in turn in a direction perpendicular to the one direction. Thus, the spotted pattern is projected over the entire measuring area of the measuring object.

Further, the profile measuring apparatus 100 of the embodiments shown in FIG. 1 has a common configuration with that of each embodiment which will be described individually hereinafter. In FIG. 1, the profile measuring apparatus 100 includes a measuring apparatus body 1 and a controller 4. The aftermentioned controller 4 is connected to the measuring apparatus body 1 through a control line to control the measuring apparatus body 1. The measuring apparatus body 1 includes a probe driver 11, a head unit 13, a surface plate 14, and an optical probe 2. Further, the spherical measuring object 3 is shown here as an example, and placed on the surface plate 14.

The surface plate 14 is made of stone or cast iron, and keeps its upper surface in a horizontal attitude. Based on a drive signal supplied from the controller 4, the probe driver 11 moves the head unit 13 in three directions of the mutually orthogonal X axis, Y axis and Z axis. Further, based on the drive signal supplied from the controller 4 in like manner, it is also possible to rotate the optical probe 2 about the X axis, about the Y axis, and about the Z axis. The probe driver 11 includes an X-axis movement unit 111, a Y-axis movement unit 112, a Z-axis movement unit 113, and a rotation mechanism 114. Here, the X-Y plane defines a plane parallel to the upper surface of the surface plate 14. That is, the X-axis direction defines one direction in the plane parallel to the upper surface of the surface plate 14, the Y-axis direction defines the direction orthogonal to the X-axis direction in the plane parallel to the upper surface of the surface plate 14, and the Z-axis direction defines the direction orthogonal to the upper surface of the surface plate 14.

The X-axis movement unit 111 includes an X-axis motor for driving the head unit 13 in the X-axis direction, and moves the head unit 13 in the X-axis direction within a predetermined range over the surface plate 14. The Y-axis movement unit 112 includes a Y-axis motor for driving the head unit 13 in the Y-axis direction, and moves the head unit 13 in the Y-axis direction within a predetermined range over the surface plate 14. Further, The Z-axis movement unit 113 includes a Z-axis motor for driving the head unit 13 in the Z-axis direction, and moves the head unit 13 in the Z-axis direction within a predetermined range. Further, the rotation mechanism 114 includes a rotary joint mechanism configured to be capable of rotating the optical probe 2 about the X axis, about the Y axis and about the Z axis, and a rotary drive motor for driving the rotary joint mechanism, whereby it is possible to change the postures of the optical probe 2 about the X axis, about the Y axis, and about the Z axis. Further, the head unit 13 is located above the optical probe 2 to support the optical probe 2. That is, the probe driver 11 moves the optical probe 2 in the directions of the axes of a three-dimensional system with mutually orthogonal coordinates, respectively.

The optical probe 2 irradiates the measuring object 3 with the spot light, and detects the spot light image from a different direction with the light irradiation direction. The optical probe 2 will be described in detail hereinafter.

### First Embodiment

Next, a first embodiment will be explained. In the first embodiment, the utilizing region of the CMOS sensor 251 is selected based on the irradiation direction of the spot light. FIGS. 2A and 2B are schematic views showing a construction of the optical probe 2 in accordance with the first embodiment. As shown in FIG. 2A, the optical probe 2 includes a spot light source unit 20, a scanner 23, an imaging lens 24, and the CMOS sensor 251. Further, the CMOS sensor 251 is provided in an aftermentioned light receiving detector 25.

The spot light source unit 20 radiates on the measuring object 3 the spot light which is a light flux having a spotted light intensity distribution. That is, the spot light source unit 20 forms a spotted pattern by irradiating the measuring object 3 with the light from a light source 21. The spot light source unit 20 includes the light source 21 and a condenser lens 22. The light source 21 is, for example, an LED device, a laser light source, a super luminescent diode (SLD) device or the like. The light source 21 radiates the spot light on the measuring object 3 via the condenser lens 22 and the scanner 23. The condenser lens 22 is arranged between the light source 21 and the scanner 23 for obtaining the spot light from the light flux radiated by the light source 21.

The scanner 23 is, for example, a galvanic mirror, arranged between the spot light source unit 20 and the measuring object 3. The scanner 23 reflects the spot light radiated from the spot light source unit 20 to irradiate the measuring object 3. Further, based on a control signal, the scanner 23 changes the irradiation direction (irradiation angle) of the spot light irradiating the measuring object 3 such that an area in which an measurement is available when a linear pattern is projected on the measuring object can be measured. Further, in the following explanations, simply the term “flying spot scanning” may sometimes be utilized to refer to scanning the optical probe 1 in a direction orthogonal to the scanning direction of the spot light while scanning the spot light so that the area in which an measurement is available when a linear pattern is projected on the measuring object can be measured. That is to say, the scanner 23 changes the deflection direction of the spot light relative to the imaging lens 24, and relatively scans the surface of the measuring object 3 with the spot light. For example, the scanner 23 scans the surface of the measuring object 3 with the spot light (the spotted pattern) by changing the irradiation direction when light irradiates the measuring object 3. The detailed configuration of the scanner 23 will be described hereinafter. Then, when the entire scanning area is scanned with the spot light by the galvanic mirror, then the probe driver 11 starts driving to relatively move the measuring object 3 and the optical probe 2 in a direction orthogonal to the scanning direction of the spot light due to the galvanic mirror. Further, the scanning with the spot light due to the galvanic mirror may as well be carried out simultaneously with the relative moving of the optical probe 2 and the measuring object 3 by the probe driver 11.

The imaging lens 24 is arranged between the measuring object 3 and the CMOS sensor 251 to collect or condense the spot light scattered by the measuring object 3 and form an image on a light-receiving pixel plane of the CMOS sensor 251.

The CMOS sensor 251 has a plurality of light-receiving pixels arranged in two dimensions for detecting the spot light image formed on the light-receiving pixel plane. As shown in FIG. 2B, in the CMOS sensor 251, among the plurality of light-receiving pixels, a group of the light-receiving pixels, in which the light-receiving pixels are aligned in a direction (an epipolar line direction) orthogonal to the displacement direction of the spot light image (the spot light scanning direction) when scanning with the spot light, is set as one detection line. Further, in the CMOS sensor 251, different detection lines are set respectively at different positions (the light-receiving pixels) in the displacement direction of the spot light image (the spot light scanning direction). Further, among the plurality of detection lines, the region of the detection line utilized for detection is selected by an aftermentioned ROI selection processor 70 according to the irradiation direction of the spot light.

Further, the imaging system of the optical probe 2 is a so-called shine-proof optical system, and the principal plane of the imaging lens 24 is formed to be orthogonal to an optical axis 25L of the imaging lens 24. Further, the light-receiving pixel plane of the CMOS sensor 251 is arranged to be oblique to the plane orthogonal to the optical axis. Thus, a focal plane 20f in conjugated relation with the light-receiving pixel plane is oblique to the plane orthogonal to optical axis, and intersects the principal plane of the imaging lens 24 and the light-receiving pixel plane at a same axis. Then, in the optical probe 2 of the first embodiment, the focal plane 20f consists with the irradiation section plane of the spot light. The focal plane 20f is positioned in such a manner as to include within its plane the centers of the light fluxes shed on the measuring object 3 from the spot light source unit 20 and the scanner 23 (the galvanic mirror). Therefore, as shown in FIG. 2A, an extended line 24L through the center of the imaging lens 24 from the principal plane intersects an extended line 251L of the epipolar line which is the detection line of the CMOS sensor 251, on an irradiation optical axis 20L of the spot light.

By virtue of the above configuration, in the imaging system of the optical probe 2, it is possible to take the spot light image on the irradiation optical axis 20L in consistency with the focal plane 20f constantly in a focalized state regardless of the measuring object 3.

FIG. 2B shows an example of the spot light image formed in the CMOS sensor 251. The figure shows the light-receiving pixel plane of the CMOS sensor 251. Here, in FIG. 2B, the longitudinal direction of the CMOS sensor 251 (the V (vertical) direction) is the displacement direction of the spot light image due to the spot light scanning (the spot light scanning direction). The transverse direction of the CMOS sensor 251 (the H (horizontal) direction) is the detection direction of the positional displacement of the spot light image (the detection direction of the spot light image). The spot light image SP0 shown in FIG. 2B illustrates spot light images formed on the light-receiving pixel plane of the CMOS sensor 251 obtained at each time by changing the irradiation direction of the spot light while scanning with the spotted pattern. Each spot light image is displaced in the detection direction of the spot light image (the H direction) according to the position in the height direction (the Z-axis direction) of the measuring object 3. Therefore, by detecting the positions of the spot light images in the H direction, it is possible to detect the position of the measuring object 3 in the height direction (the Z-axis direction).

Further, among the plurality of detection lines of the CMOS sensor 251, the region to be utilized (also referred to as a ROI (Region Of Interest)) is selected by an aftermentioned ROI selector 461. Further, the ROI mentioned here refers to an object area of the CMOS sensor 251 to be utilized for detecting the spot light images, defining a scope of the detection lines to be utilized for detecting the spot light images.

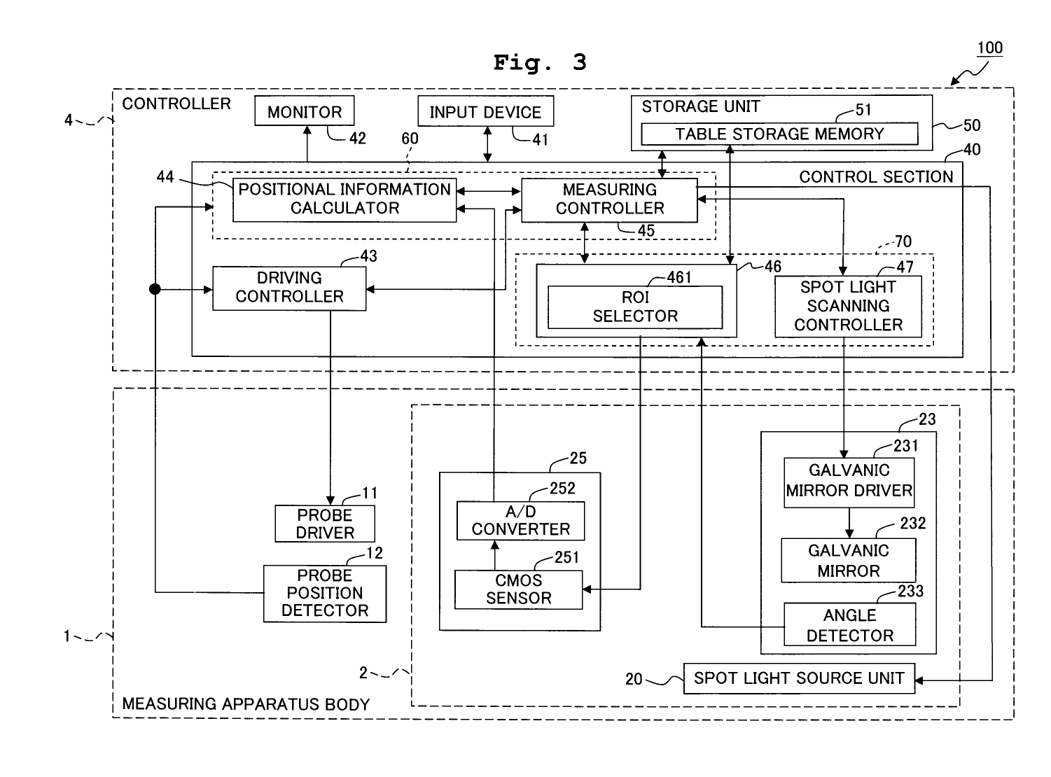

Next, referring to FIG. 3, a configuration of the profile measuring apparatus 100 will be explained in detail. FIG. 3 is a block diagram outlining the configuration of the profile measuring apparatus 100 in accordance with the first embodiment. Further, in this figure, the identical or equivalent constituents or components to those in FIGS. 1, 2A and 2B are designated by the identical reference numerals, any explanations for which will be omitted.

In FIG. 3, the profile measuring apparatus 100 includes the measuring apparatus body 1 and the controller 4. Further, the measuring apparatus body 1 includes the aforementioned probe driver 11, a probe position detector 12, and the optical probe 2. Based on a drive signal supplied from the controller 4, the probe driver 11 changes the position of the optical probe 2.

The probe position detector 12 includes an encoder for X axis, an encoder for Y axis and an encoder for Z axis to detect the positions of the probe driver 11 in the directions of the X axis, Y axis and Z axis, respectively. The probe position detector 12 detects the positions of the probe driver 11 by these encoders, and supplies a signal indicating the position of the probe driver 11 to an aftermentioned control section 40 (a positional information calculator 44 and a driving controller 43).

As described hereinbefore, the optical probe 2 includes the spot light source unit 20, the scanner 23 and the light receiving detector 25 for detecting the surface profile of the measuring object 3 by the light-section method.

The light receiving detector 25 (a light receiver) includes the aforementioned CMOS sensor 251 and an A/D (analog/digital) converter 252 to detect the spot light image when the measuring object 3 is irradiated with the spot light from a different direction with the irradiation direction of the spot light irradiating the measuring object 3. That is, it detects the spot light image (the light-section line) formed on the surface of the measuring object 3 by the irradiation light from the spot light source unit 20, and supplies the detection result to the control section 40 (the positional information calculator 44). By virtue of this, the controller 4 obtains a profile measuring data. The A/D converter 252 converts the analog signal supplied from the CMOS sensor 251 into a digital signal, and supplies the digital signal to the control section 40 (the positional information calculator 44).

The scanner 23 includes a galvanic mirror driver 231, a galvanic mirror 232, and an angle detector 233. Based on a control signal supplied from the control section 40 (a spot light scanning controller 47), the galvanic mirror driver 231 changes the angle of the galvanic mirror 232. That is, the galvanic mirror driver 231 changes the direction of irradiating the measuring object 3 with the spot light for irradiating the spot light sequentially at measurement areas having a line shape.

The angle detector 233 is, for example, an encoder for detecting the angle of the galvanic mirror 232. The angle detector 233 supplies the detected angular information to the control section 40 (a light receiving controller 46).

Next, the controller 4 will be explained. The controller 4 includes the control section 40, an input device 41, a monitor 42, and a storage unit 50.

The input device 41 includes a keyboard, a joystick and the like for users to input information of various instructions. The input device 41 detects the inputted instruction information and stores the detected instruction information into the storage unit 50. The input device 41 such as the joystick receives a user's instruction, and generates a control signal according to the instruction for driving the probe driver 11 to supply the control signal to the control section 40. The monitor 42 receives the measuring data (the coordinate values of all measuring points) and the like supplied from the control section 40. The monitor 42 displays the received measuring data (the coordinate values of all measuring points) and the like. Further, the monitor 42 displays a measuring screen, an instruction screen, and the like.

The storage unit 50 stores measuring conditions supplied from the input device 41, and measuring data supplied from the control section 40. Further, the storage unit 50 includes a table storage memory 51. The table storage memory 51 stores an aftermentioned selection table. As this selection table, the table storage memory 51 associates the irradiation direction of the spot light with the detection line region (ROI) utilized for detection among the plurality of detection lines, and then stores the both. By utilizing the selection table, based on the irradiation direction of the spot light, it is possible to select the detection line region (ROI) utilized for detection.

The control section 40 controls the process of measuring the profile of the measuring object 3 in the profile measuring apparatus 100, calculates the height of the surface of the measuring object 3 from the reference plane, and carries out a computation process to find a three-dimensional profile of the measuring object 3. That is, the control section 40 (the ROI selection processor 70) selects the signals of the light-receiving pixels utilized for detecting the position of the spot light image formed on the light-receiving pixel plane of the CMOS sensor 251. That is, the control section 40 (the ROI selection processor 70) selects a plurality of light-receiving pixels which include light-receiving pixels located at the position of the spot light image formed in the CMOS sensor 251 and which are aligned in a different direction (the epipolar line direction or the detection direction of the spot light image) from the displacement direction of the spot light image (the scanning direction of the spot light) when scanning with the light flux. Then, based on the signals from the selected light-receiving pixels, the control section 40 (a position computation processor 60) calculates the positional information of the measuring object 3.

Further, the control section 40 includes the driving controller 43, the positional information calculator 44, a measuring controller 45, the light receiving controller 46, and the spot light scanning controller 47. Further, in the configuration of the control section 40, the positional information calculator 44 and measuring controller 45 correspond to the position computation processor 60 (a controller), and the light receiving controller 46 and spot light scanning controller 47 correspond to the ROI selection processor 70 (a changing unit).

Based on a manipulation signal from the input device 41, or based on an instruction signal from the measuring controller 45, the driving controller 43 supplies a drive signal to the probe driver 11, and carries out the control to move the probe driver 11. Further, based on the positional information of the probe driver 11 supplied from the probe position detector 12, the driving controller 43 moves the probe driver 11.

The positional information calculator 44 calculates the positional information of the measuring object 3, based on the signals from the light-receiving pixels selected by the ROI selection processor 70. That is, the positional information calculator 44 calculates the position of the surface of the measuring object 3 by utilizing the principle of triangulation and the like, based on the positional information of the optical probe 2 supplied from the probe position detector 12, and the displacement information of the spot light image supplied from the light receiving detector 25.

The measuring controller 45 controls various processes for measuring the profile of the measuring object 3 based on the measuring conditions stored in the storage unit 50. For example, the measuring controller 45 supplies probe driver 11 with a command signal to move the optical probe 2. For example, the measuring controller 45 supplies the spot light source unit 20 with another command signal to control the intensity of the spot light for irradiation. Further, via the light receiving controller 46, the measuring controller 45 causes the light receiving detector 25 to detect the spot light image based on the selected detection line region (ROI). The measuring controller 45 stores into the storage unit 50 the positional information of the measuring object 3 calculated by the positional information calculator 44.

The light receiving controller 46 is controlled based on the command signal supplied from the measuring controller 45. The light receiving controller 46 carries out various controls for the light receiving detector 25. Further the light receiving controller 46 includes the ROI selector 461.

the ROI selector 461 selects the detection line region (ROI) utilized for detection, among the plurality of detection lines of the CMOS sensor 251, according to the irradiation direction of the spot light. Further, from the plurality of light-receiving pixels of the CMOS sensor 251, the ROI selector 461 sets a light-receiving pixel group as one detection line aligned in a direction orthogonal to the displacement direction of the spot light image when scanning with the spot light.

Further, in the first embodiment, the lines of the CMOS sensor 251 in the H direction correspond to the detection lines. However, the detection lines are not limited to the H direction but can be lines in an oblique direction to the H direction. That is, the detection lines are not set by the orientation of the CMOS sensor 251 but are set by the detection direction of the spot light image (the epipolar line direction).

Further, here, the direction of changing the irradiation direction of the spot light is, as described hereinbefore, the scanning direction of the spotted pattern, as well as the direction of changing the irradiation orientation of the spot light from the galvanic mirror 232. The ROI selector 461 detects the irradiation direction of the spot light based on the angular information detected by the angle detector 233 of the scanner 23.

The ROI selector 461 selects the detection line region (ROI) based on a selection reference associating the irradiation direction of the spot light with the detection line region (ROI) utilized for detection among the plurality of detection lines. The selection reference mentioned here is, for example, a selection table, a predetermined selection rule, a computation result of a selection function, and the like. In the first embodiment, based on the selection table, as an example, explanations will be made with respect to the case of selecting the detection line region (ROI).

The ROI selector 461 selects the detection line region (ROI) based on the selection table previously stored in the table storage memory 51. The ROI selector 461 supplies the CMOS sensor 251 with information for designating the detection line region (ROI) selected according to the irradiation direction of the spot light. By virtue of this, the detection lines are selected including the spot light image formed by the spot light radiated in the irradiation direction of the spot light.

Based on the command signal supplied from the measuring controller 45, the spot light scanning controller 47 controls the scanning of the spot light. That is, the spot light scanning controller 47 controls the galvanic mirror driver 231 of the scanner 23 to change the angle of the galvanic mirror 232.

Next, explanations will be made with respect to a measuring operation of the profile measuring apparatus 100 in the first embodiment. Further, the operation will be explained assuming that the measuring condition has been set and the optical probe 2 has moved to a measuring start position. First, based on the measuring condition, the measuring controller 45 commands the spot light scanning controller 47 for scanning of the spot light. Based on the command signal supplied from the measuring controller 45, the spot light scanning controller 47 controls the galvanic mirror driver 231 of the scanner 23 to change the angle of the galvanic mirror 232. By virtue of this, the spot light radiated from the spot light source unit 20 irradiates the measuring object 3 in the changed irradiation direction. Further, the angle detector 233 detects the angle of the galvanic mirror 232, and supplies the light receiving controller 46 with the detected angular information.

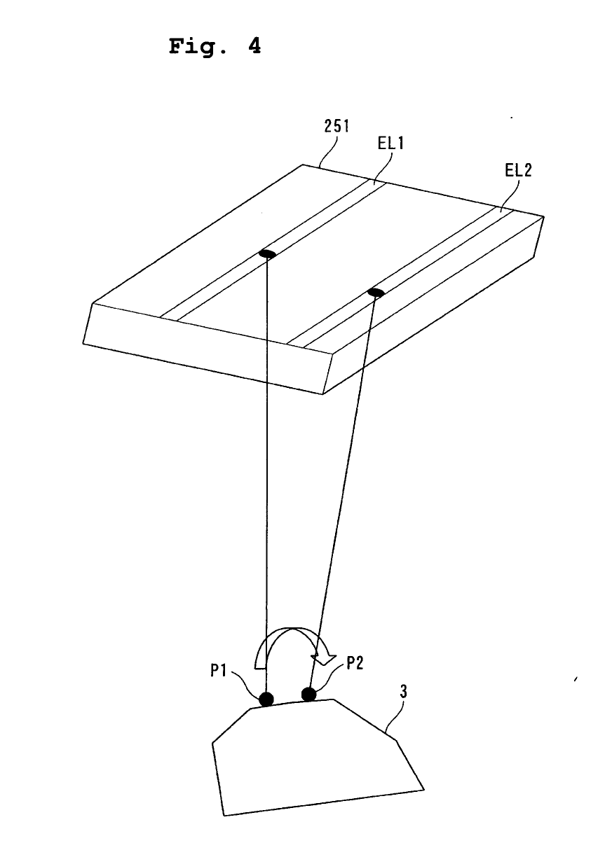

FIG. 4 shows a scanning image of the spot light in accordance with the first embodiment. In the case of having changed the irradiation direction of the spot light radiated from the spot light source unit 20, the spot light changes the position of its image formed on the measuring object 3. Then, in FIG. 4, when the spot light scans from the point P1 to the point P2, for example, the position of the spot light image formed in the CMOS sensor 251 changes from the detection line EL1 to the detection line EL2.

Next, the ROI selector 461 of the light receiving controller 46 detects the irradiation direction of the spot light based on the angular information detected by the angle detector 233 of the scanner 23. The ROI selector 461 selects the detection line region (ROI) based on the irradiation direction of the spot light, and the selection table stored in the table storage memory 51. The ROI selector 461 supplies the CMOS sensor 251 of the light receiving detector 25 with information for designating the selected detection line region (ROI). By virtue of this, the detection line region (ROI) is selected corresponding to the irradiation direction of the spot light.

Next, the CMOS sensor 251 reads out the detection signals of the light-receiving pixels corresponding to the detection line region (ROI) selected by the ROI selector 461, and supplies the detection signals to the A/D converter 252. The A/D converter 252 converts the analog signals outputted from the CMOS sensor 251 into digital signals, and supplies the positional information calculator 44 with information including the displacement information of the spot light image in the epipolar line direction (the H direction).

The positional information calculator 44 utilizes the principle of triangulation and the like to calculate the surface position of the measuring object 3 based on the positional information of the optical probe 2 supplied from the probe position detector 12, and the displacement information of the spot light image supplied from the light receiving detector 25. The positional information calculator 44 supplies the measuring controller 45 with the calculated positional information of the measuring object 3.

The measuring controller 45 causes the storage unit 50 to store the positional information of the measuring object 3 calculated by the positional information calculator 44. Further, the measuring controller 45, once again, commands the spot light scanning controller 47 for scanning of the spot light, changes the position of the spot light irradiating the measuring object, and causes the light receiving controller 46, the light receiving detector 25 and the positional information calculator 44 to carry out the same measurements as mentioned above. Further, in equivalent cases to finishing the scanning of the spot light and finishing a series of measurements, in which the spot lights are irradiated in the line-shaped measuring area and the images thereof are obtained, the measuring controller 45 causes the driving controller 43 to change the position of the optical probe 2. For example, the measuring controller 45 causes the driving controller 43 to change the position of the line-shaped measuring area of the surface of the measuring object 3. Then, the measuring controller 45 repeats the same process as mentioned above for the changed light-section lines. By virtue of this, the profile of the measuring object 3 is measured.

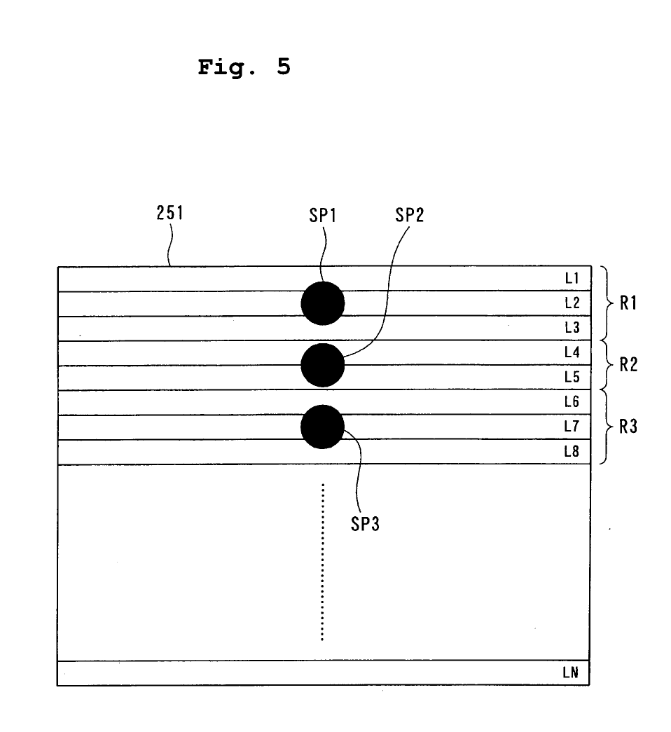

Next, the selection table will be explained. FIG. 5 shows an example of ROI selection of the CMOS sensor 251 in accordance with the first embodiment. In this figure, the CMOS sensor 251 includes a plurality of detection lines L1 to LN. For example, the three detection lines L1 to L3 constitute a detection line region (ROI) R1 where a spot image SP1 is formed to correspond to the case that the irradiation direction of the spot light is a first direction. Further, the two detection lines L4 and L5 constitute a detection line region (ROI) R2 where a spot image SP2 is formed to correspond to the case that the irradiation direction of the spot light is a second direction different from the first direction. Further, the three detection lines L6 to L8 constitute a detection line region (ROI) R3 where a spot image SP3 is formed to correspond to the case that the irradiation direction of the spot light is a third direction different from the first and second directions.

The selection table stored in the table storage memory 51 is such kind of information associating the irradiation direction of the spot light with the detection line region (the scope of detection lines). Further, as shown in this figure, the number of detection lines in the detection line region can be changed according to the positions of the formed spot light images. Alternatively, the number of detection lines in the detection line region can be fixed regardless of the positions of the formed spot light images. Still alternatively, above described situations can be combined. That is, the number of detection lines in a part of the detection line regions can be changed according to the positions of the formed spot light images, whereas the number of detection lines in the remaining detection line regions can be fixed regardless of the positions of the formed spot light images.

Further, the selection table is generated in advance based on the irradiation direction of the spot light and the utilized detection lines which are obtained when having measured the measuring object 3 of a predetermined profile. For example, with an object as the measuring object 3 parallel to the X-Y plane of FIG. 1, a detection line scope (region) is measured for the actually formed spot light image by scanning with the spot light in each irradiation direction of the spot light. Based on this measuring result, the selection table is generated.

Further, in FIG. 5, the detection line regions (ROI) R1 and R3 are defined to be wider than the diameter of the spot light image in the direction perpendicular to the longitudinal direction of the detection lines. That is, the ROI selector 461 can determine the detection line region (ROI) to be wider than the diameter of the spot light image and, in this detection line region (ROI), the positional information calculator 44 can calculate the positional information of the measuring object 3 based on the detection result by the detection lines including positions with the brightest spot light image. In this case, by determining the region wider than the diameter of the spot light image, it is possible to reliably capture the spot light image. Further, it is not indispensable to calculate the positional information of the measuring object 3 based on the detection result by the detection lines including positions with the brightest spot light image. For example, it is possible to calculate the positional information of the measuring object 3 by carrying out desired computation processes and the like for the measuring data of the spot light image as necessary. For example, it is possible to calculate the positional information of the measuring object 3 based on the detection result by the detection lines including the barycentric position of the light intensity distribution of the spot light images.

As described hereinabove, in the profile measuring apparatus 100 of the first embodiment, the spot light source unit 20 radiates the spot light onto the measuring object 3, and the scanner 23 relatively scans the surface of the measuring object 3 with the spot light. Further, the light receiving detector 25 (the light receiver) has a plurality of light-receiving pixels aligned in two dimensions to detect the spot light image from a different direction with the direction of the spot light irradiating the measuring object 3. Further, among the plurality of light-receiving pixels of the light receiving detector 25, the ROI selection processor 70 (the changing unit) selects (changes) the light-receiving pixel signals utilized to detect the position of the spot light image according to the irradiation direction of the spot light. The position computation processor 60 (the controller) calculates the positional information of the measuring object 3 based on the signals from the light-receiving pixels selected by the ROI selection processor 70.

By virtue of this, the profile measuring apparatus 100 utilizes the light-receiving pixels corresponding to the irradiation direction of the spot light to detect the position of the spot light image, among the light-receiving pixels aligned in two dimensions (in the CMOS sensor 251). Therefore, it is possible to reduce the influence (misdetection) from lights out of the epipolar line (environmental lights and multiply-reflected lights). Therefore, the profile measuring apparatus 100 of the first embodiment is able to accurately measure the profile of the measuring object 3. Further, in order to form the spot light image of scanning on one detection line sensor, it is generally necessary to have complicated mechanisms and carry out advanced adjustment operations. However, because the profile measuring apparatus 100 of the first embodiment utilizes the light-receiving pixels aligned in two dimensions (in the CMOS sensor 251), there is no such necessity. That is, the profile measuring apparatus 100 of the first embodiment is able to accurately measure the profile of the measuring object 3 without requiring any complicated mechanisms and advanced adjustment operations.

Further, in the first embodiment, the ROI selection processor 70 (the ROI selector 461) selects a plurality of light-receiving pixels which include light-receiving pixels located at the position of the spot light image formed in the light receiving detector 25 (the CMOS sensor 251) and which are aligned in a different direction from the displacement direction of the spot light image when scanning with the spot light. That is, the ROI selector 461 selects a plurality of light-receiving pixels (detection lines) according to the irradiation direction of the spot light in the epipolar direction (the H direction) different from the scanning direction of the spot light (the V direction) in the CMOS sensor 251. By virtue of this, because of selecting a plurality of light-receiving pixels aligned in the direction of detecting the position of the formed the spot light image, it is possible to correctly select the position of the formed the spot light image. Hence, the profile measuring apparatus 100 of the first embodiment is able to accurately measure the profile of the measuring object 3.

Further, in the first embodiment, among the plurality of light-receiving pixels, the ROI selection processor 70 (the ROI selector 461) sets a group of the light-receiving pixels as one detection line aligned in a direction orthogonal to the displacement direction of the spot light image when scanning with the spot light, and sets a plurality of detection lines for different positions respectively in the displacement direction of the spot light image. Then, the ROI selection processor 70 (the ROI selector 461) selects the detection line region utilized for detection from the plurality of detection lines according to the irradiation direction of the spot light. Further, the position computation processor 60 (the measuring controller 45) causes the light receiving detector 25 to detect the spot light image by the selected detection line region. By virtue of this, because the detection region (ROI) can be set in detection line units, by which it is possible to read out the displacement position of the spot light image, the measuring time can be shortened. Further, it is possible to make the detection line region (the number of detection lines utilized for the measuring) be variable with the irradiation direction of the spot light. Therefore, it is applicable even in cases in which changes arise in the number of detection lines necessary for detection according to the irradiation direction of the spot light.

Further, in the first embodiment, the ROI selection processor 70 (the ROI selector 461) selects the detection line region based on a selection reference associating the irradiation direction of the spot light with the detection line region utilized for detection among the plurality of detection lines. That is, the ROI selection processor 70 (the ROI selector 461) selects the detection line region based on a selection reference such as a selection table, a predetermined selection rule, a computation result of a selection function, and the like. By virtue of this, because it is possible to select the optimum detection line region by an easy method, the profile measuring apparatus 100 of the first embodiment is able to accurately measure the profile of the measuring object 3.

Further, in the first embodiment, the aforementioned selection reference is established by the selection table associating the irradiation direction of the spot light with the utilized detection line region. Further, the profile measuring apparatus 100 includes the table storage memory 51 (the storage unit) for storing the selection table, which is generated in advance based on the irradiation direction of the spot light and utilized detection lines obtained when having measured the measuring object 3 of a predetermined profile. By virtue of this, it is possible to carry out calibration on the manufactured profile measuring apparatus 100 by utilizing the generated selection table. For example, it is conceivable that the position of the CMOS sensor 251 varies a little with each of a plurality of manufactured profile measuring apparatuses 100. However, according to the first embodiment, it is possible to generate the selection table as described hereinabove based on the irradiation direction of the spot light and utilized detection lines obtained when having measured the measuring object 3 of a predetermined profile for each profile measuring apparatus 100. Then, by utilizing the selection table, the ROI selection processor 70 (the ROI selector 461) is able to select the optimum detection line region in any profile measuring apparatus 100. Therefore, because it is not necessary to carry out positioning of the CMOS sensor 251 in an overstrict manner, it is possible to assemble the profile measuring apparatus 100 without increasing the adjustment man-hours for positioning the CMOS sensor 251. Hence, the profile measuring apparatus 100 of the first embodiment is able to accurately measure the profile of the measuring object 3.

### Second Embodiment

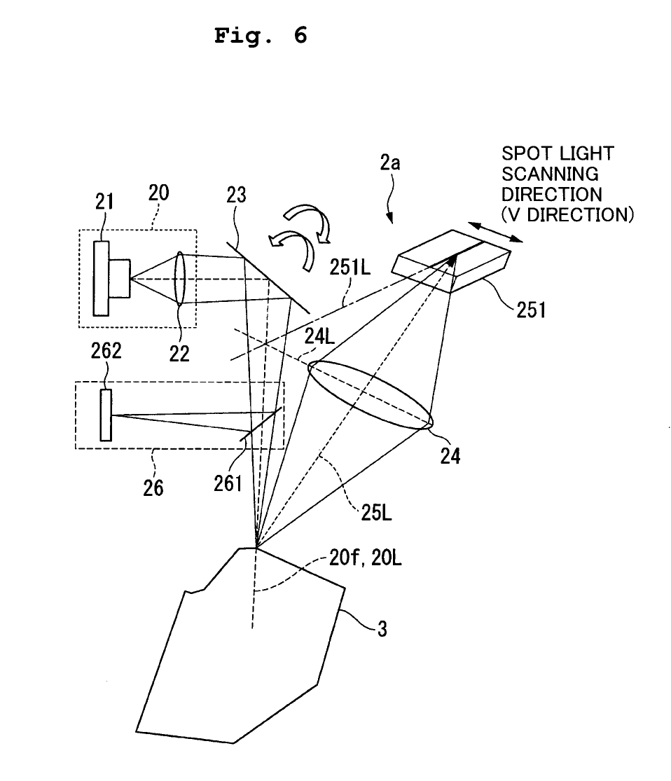

Next, a second embodiment will be explained. In the second embodiment, the irradiation direction of the spot light is detected by detecting the actual position of the spot light irradiation instead of the angular information detected by the angle detector 233. FIG. 6 is a schematic view showing a construction of an optical probe 2a in accordance with the second embodiment. In FIG. 6, the optical probe 2a includes the spot light source unit 20, the scanner 23, the imaging lens 24, the CMOS sensor 251, and an irradiation position detector 26. In this figure, the identical or equivalent constituents or components to those in FIGS. 1, 2A and 2B are designated by the identical reference numerals, any explanations for which will be omitted.

The irradiation position detector 26 has an optical path branching unit 261 for branching the spot light, and a branched light receiver 262 (a light-receiving element) to be irradiated with the branched spot light, to detect the irradiation position of the branched spot light irradiating the branched light receiver 262. The optical path branching unit 261 is, for example, a half mirror, for branching part of the spot light (the branched spot light) to irradiate the branched light receiver 262. The branched light receiver 262 is, for example, a light-receiving element such as a CMOS sensor or the like, for detecting the position of the branched spot light.

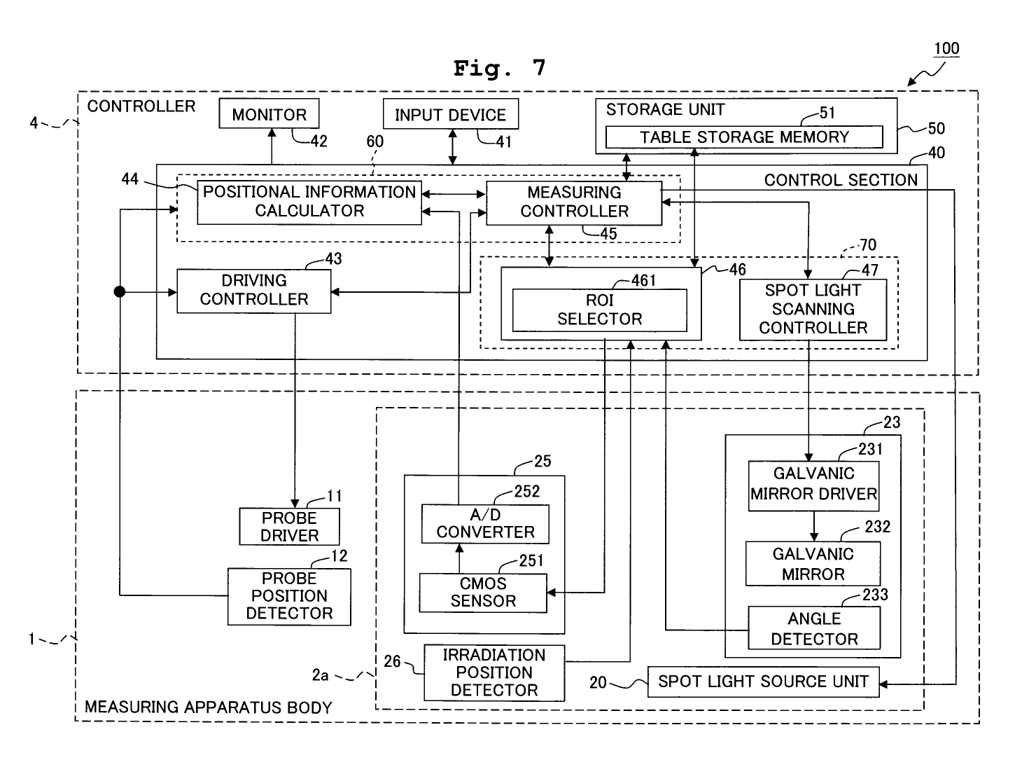

FIG. 7 is a block diagram outlining a configuration of the profile measuring apparatus 100 in accordance with the second embodiment. Further, in this figure, the identical or equivalent constituents or components to those in FIGS. 1 to 3 are designated by the identical reference numerals, any explanations for which will be omitted.

In FIG. 7, except for the aspect that the optical probe 2 is replaced by the optical probe 2a shown in FIG. 6, the profile measuring apparatus 100 of the second embodiment is identical to that shown in FIG. 3.

In the second embodiment, the optical probe 2a includes the irradiation position detector 26, and supplies the light receiving controller 46 with detection information (positional information of the branched spot light). The ROI selector 461 of the light receiving controller 46 detects the irradiation direction of the spot light based on the detection information detected by the irradiation position detector 26 (the branched light receiver 262). That is, the ROI selector 461 detects the irradiation direction of the spot light based on the actual position of the spot light irradiation instead of the angular information of the angle detector 233.

In the above manner, in the second embodiment, because the irradiation direction of the spot light is detected from the actual position of the spot light irradiation, it is possible to detect the correct irradiation direction of the spot light. Further, in the same manner as in the first embodiment, the profile measuring apparatus 100 of the second embodiment is able to accurately measure the profile of the measuring object 3 without requiring any complicated mechanisms and advanced adjustment operations.

Further, the method for detecting the irradiation direction of the spot light can be based on the control signal for controlling the scanner 23 by the spot light scanning controller 47. In this case, because it is not necessary to have the angle detector 233 and the irradiation position detector 26, it is possible to detect the irradiation direction of the spot light with a simplified configuration.

Further, the ROI selection processor 70 (the ROI selector 461) can detect the irradiation direction of the spot light based on any one or any combination of the control signal for controlling the scanner 23, the detection information by the angle detector 233 for detecting the angle of the spot light irradiation due to the scanner 23, and the detection information by the irradiation position detector 26, which has the branched light receiver 262 (the light-receiving element) irradiated with the branched spot light and which detects the irradiation position of the branched spot light irradiating the branched light receiver 262. When detecting the irradiation direction of the spot light based on some combination, because the irradiation direction of the spot light can be detected by a plurality of systems, it is possible to detect the correct irradiation direction of the spot light.

### Third Embodiment

Next, a third embodiment will be explained. The third embodiment shows another configuration of the spot light source unit 20. Except for the aspect that the spot light source unit 20 is replaced by a spot light source unit 20a, the profile measuring apparatus 100 of the third embodiment is identical to each of the aforementioned embodiments.

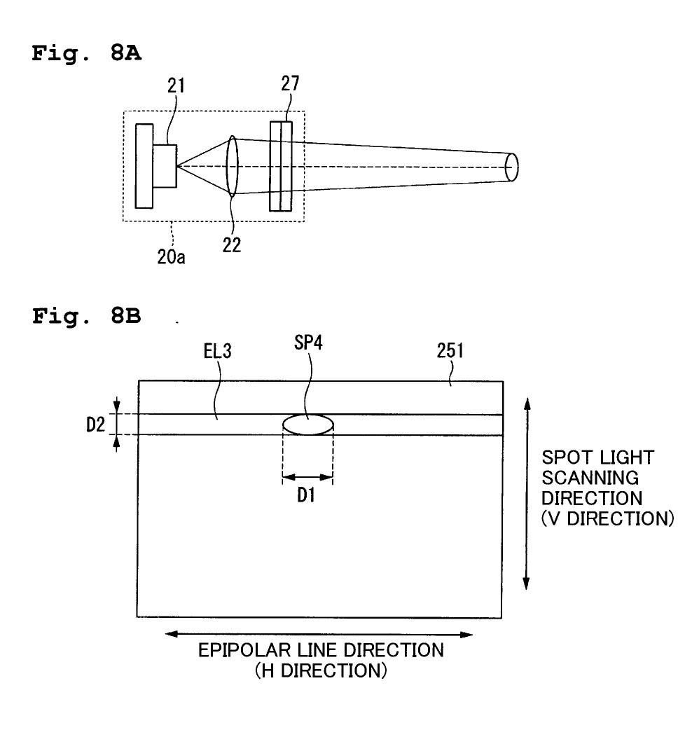

FIGS. 8A and 8B are block diagrams outlining a configuration of the spot light source unit 20a in accordance with the third embodiment. In FIG. 8A, the spot light source unit 20a of the third embodiment includes the light source 21, the condenser lens 22, and a cylindrical lens 27. The cylindrical lens 27 (an optical portion) is arranged behind the condenser lens 22 for causing the light receiving detector 25 (the CMOS sensor 251) to form the spot light image with its diameter vertical to the detection line narrower than that parallel to the detection line. That is, the cylindrical lens 27 projects onto the measuring object 3 the spot light (the spotted pattern) with its diameter vertical to the detection line narrower than that parallel to the detection line.

FIG. 8B shows a spot light image SP4 formed in the CMOS sensor 251 by the spot light source unit 20a. As shown in this figure, the spot light source unit 20a utilizes the cylindrical lens 27 to form the spot light image SP4 to come within the width D2 in the scanning direction of the spot light of the detection line EL3. Further, the spot light source unit 20a forms the image such that the width D1 of the spot light image SP4 in the epipolar line direction is measurable for the displacement of the spot light image SP4. Therefore, the spot light source unit 20a radiates the spot light to form the spot light image SP4 with the diameter D2 vertical to the detection line narrower than the diameter D1 parallel to the detection line.

By virtue of this, because it is possible to form the spot light image of an ellipse narrower in the scanning direction of the spot light in the CMOS sensor 251, it is possible to reduce the possibility of mistakenly detecting lights out of the epipolar line (environmental lights and multiply-reflected lights). Therefore, the profile measuring apparatus 100 of the third embodiment is able to accurately measure the profile of the measuring object 3. Further, because the detection line region can be narrowed, it is possible to shorten the measuring time (the time for reading out the detection result of the detection line region).

### Fourth Embodiment

Next, a fourth embodiment will be explained. Each of the aforementioned embodiments was explained as changes the detection line region (ROI) in the CMOS sensor 251 in synchronization with changing the irradiation direction of the spot light by the scanner 23. However, in the fourth embodiment, a case in which the irradiation direction of the spot light is related to the detection line region (ROI) in another manner is explained. In the fourth embodiment, a rolling shutter camera 25a is used as the light receiving detector 25. The scanner 23 changes the irradiation direction of the spot light in synchronization with the exposure region (time) of the rolling shutter camera 25a.

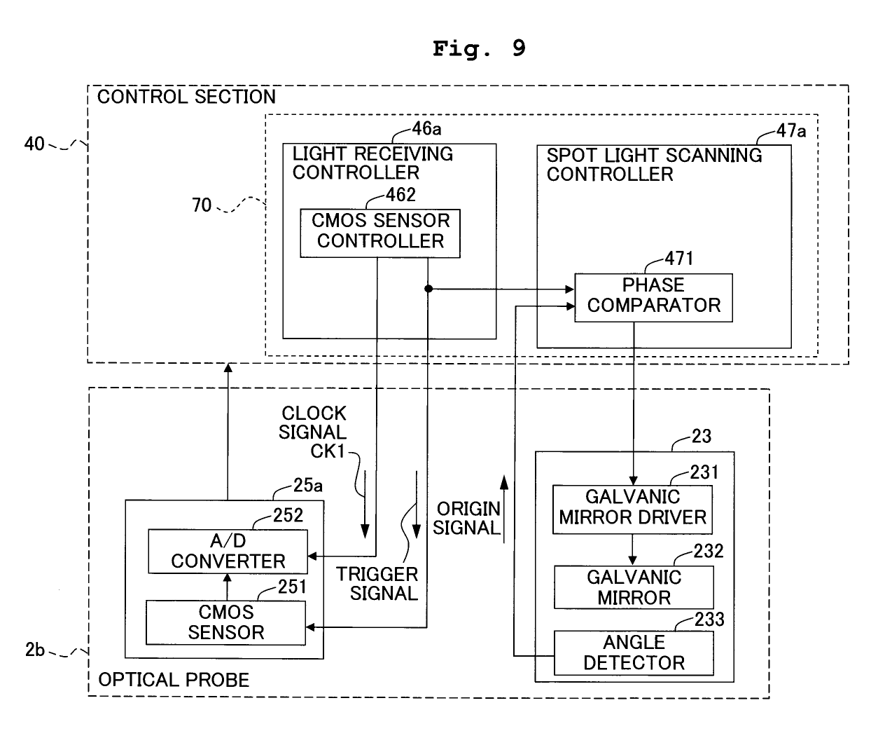

FIG. 9 is a block diagram outlining a configuration of the control section 40 and an optical probe 2b in accordance with the fourth embodiment. Further, FIG. 9 only illustrates the constituents necessary for explaining the fourth embodiment; the others are identical to those in each of the previously shown figures.

In FIG. 9, the optical probe 2b includes the rolling shutter camera 25a (a light receiving detector), and the scanner 23. The rolling shutter camera 25a starts exposing (detecting) in response to a trigger signal, and changes the detection line in turn for the exposure in the scanning direction (the V direction) of the spot light in the CMOS sensor 251 in synchronization with a clock signal CK1.

The angle detector 233 of the scanner 23 supplies a spot light scanning controller 47a with an origin signal as a part of angular information indicating that the galvanic mirror 232 is present at the origin of the scanning start point of the galvanic mirror 232. That is, this origin signal is supplied when the irradiation direction of the spot light is at the scanning start position.

The ROI selection processor 70 causes the scanner 23 to change the irradiation direction of the spot light according to the detection line region utilized for detection among the plurality of detection lines. The ROI selection processor 70 includes a light receiving controller 46a and a spot light scanning controller 47a.

The light receiving controller 46a includes a CMOS sensor controller 462, which carries out control of the rolling shutter camera 25a and supplies the rolling shutter camera 25a with the trigger signal and the clock signal CK1. The CMOS sensor controller 462 supplies the trigger signal to a phase comparator 471 in the spot light scanning controller 47a. Further, according to the scanning speed of the spot light and the diameter of the spot light image formed in the CMOS sensor 251, the CMOS sensor controller 462 determines an exposure time (an internal exposure time) so that the spot light image can be exposed to the detection line region (ROI) in the rolling shutter camera 25a.

The spot light scanning controller 47a includes the phase comparator 471, which generates a control signal for changing the angle of the galvanic mirror 232 based on the origin signal supplied from the angle detector 233 and the trigger signal supplied from the CMOS sensor controller 462. That is, the phase comparator 471 compares the phase of this origin signal with that of the trigger signal, and generates the control signal for changing the angle of the galvanic mirror 232 so that these two phases consist with each other. That is, the phase comparator 471 synchronizes the timing of outputting the origin signal with that of outputting the trigger signal.

By virtue of this, the scanning start timing of the spot light consists with the exposure start timing of the rolling shutter camera 25a and, furthermore, the scanning period of the spot light becomes equal to the period necessary for the rolling shutter camera 25a to expose one picture. As a result, the spot light scanning controller 47a changes the angle of the galvanic mirror 232 to correspond to the detection line region (the exposure region) of the rolling shutter camera 25a.

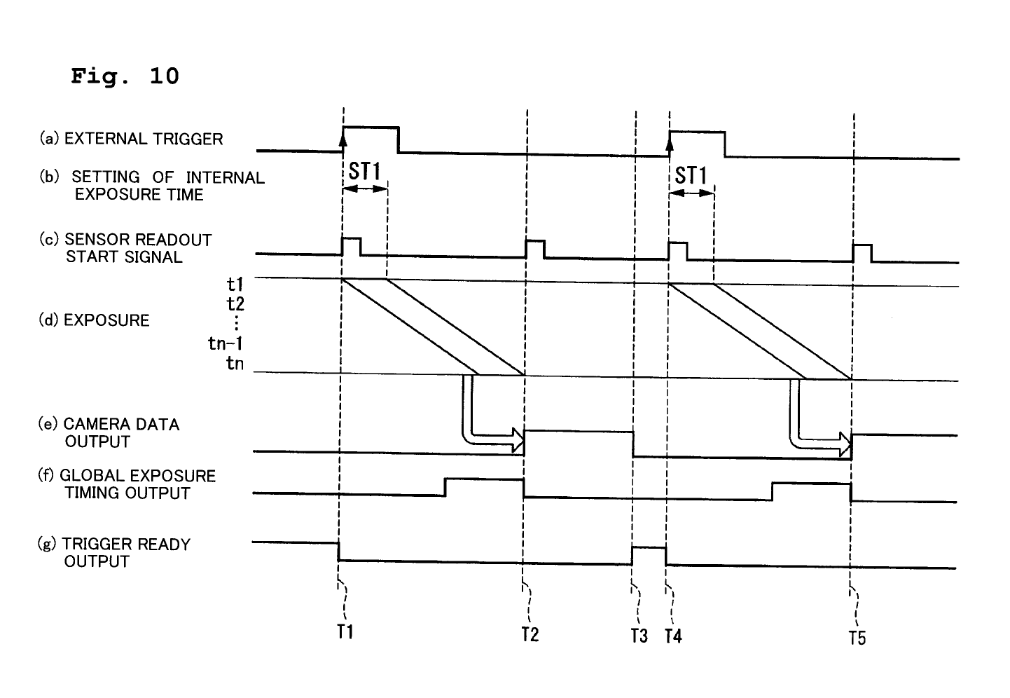

FIG. 10 is a timing chart showing an operation of the rolling shutter camera 25a in accordance with the fourth embodiment. In this figure, the horizontal axis indicates time, while in the order from the top, the vertical axis indicates: (a) external trigger (the trigger signal mentioned above); (b) internal exposure time setting; (c) sensor readout start signal; (d) exposure (exposure region); (e) camera data output; (f) global exposure timing output; and (g) trigger ready output. Further, the exposure time mentioned here refers to the time length or width for exposure.

In this example, (b) exposure time (internal exposure time) is set to be ST1. At the time T1, as the CMOS sensor controller 462 outputs (a) external trigger, the rolling shutter camera 25a internally generates (c) sensor readout start signal, and starts (d) exposure. As shown in (d) exposure, the rolling shutter camera 25a is exposed in order of the exposure timing of each detection line (from t1 to tn) at the interval of the exposure time ST1. Further, on the other hand, according to (a) external trigger, the rolling shutter camera 25a shifts (g) trigger ready output to an L (Low) state. This shows that the rolling shutter camera 25a is in a state unable to accept (a) external trigger (a busy state).

At the time T2, the rolling shutter camera 25a finishes (d) exposure, and the control section 40 obtains the detection information of the spot light image by (e) camera data output outputted after (f) global exposure timing output.

At the time T3, the rolling shutter camera 25a finishes (e) camera data output, and repeats (d) exposure over again from the time T4 to the time T5. Further, as described hereinbefore, the phase comparator 471 makes the scanning period of the spot light consist with the period from the time T1 to the time T4.

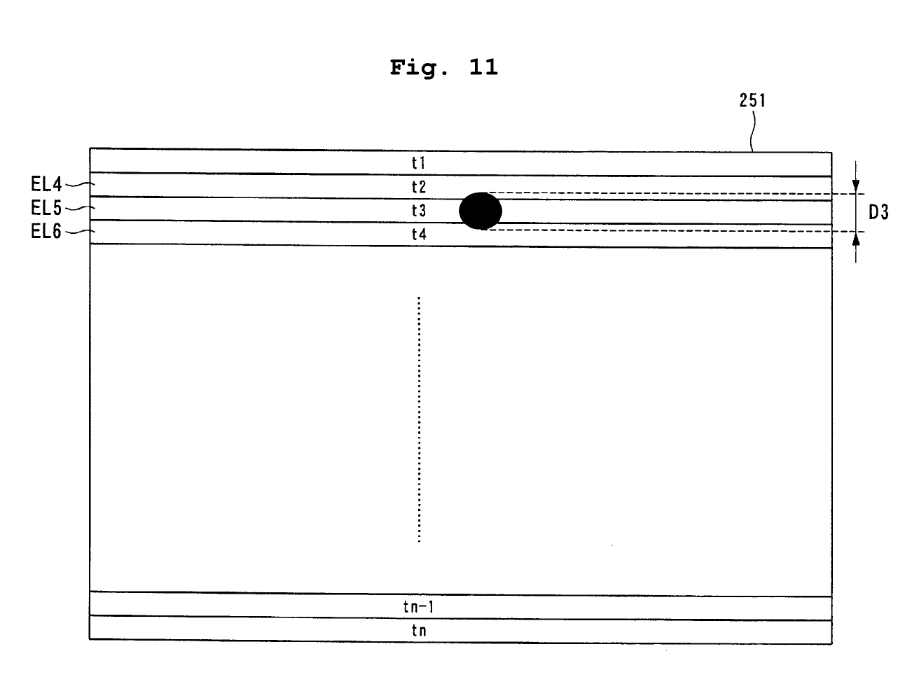

FIG. 11 is an explanatory diagram explaining an example of setting an exposure time in accordance with the fourth embodiment. In this figure, each detection line of the CMOS sensor 251 is exposed by the exposure timing (from t1 to tn). Here, the diameter D3 in the scanning direction of the spot light image is sized to fall within the three detection lines EL4 to EL6 (also referred to as scanning lines here). Therefore, the CMOS sensor controller 462 determines the scanning time (the time width) of these three detection lines as the exposure time (ST1 in FIG. 10).

That is, the exposure time is set based on the period of scanning the detection lines and the diameter D3 of the spot light image in the scanning direction. Further, the period of scanning the detection lines corresponds to the scanning period of the spot light. Further, the scanning period of the spot light corresponds to the scanning speed of the spot light. Therefore, the exposure time is set based on the scanning speed of the spot light and the diameter of the spot light image. Further, the scanner 23 changes the irradiation angle of the spot light. Therefore, the scanning speed of the spot light mentioned here refers to the change of the irradiation angle per unit of time (i.e. an angular speed).

In the above manner, in the fourth embodiment, the ROI selection processor 70 (the selector) causes the scanner 23 to change the irradiation direction of the spot light according to the detection line region (ROI) utilized for detection among the plurality of detection lines. By virtue of this, the spot light image can be detected with the detection line region (ROI) corresponding to the irradiation direction of the spot light. Therefore, in the same manner as in each of the aforementioned embodiments, the profile measuring apparatus 100 of the fourth embodiment is able to accurately measure the profile of the measuring object 3 without requiring any complicated mechanisms and advanced adjustment operations.

Further, in the fourth embodiment, the light receiving detector is the two-dimensional rolling shutter camera 25a. Then, the ROI selection processor 70 (the CMOS sensor controller 462) sets the exposure time so that the spot light image can be exposed to the detection line region (ROI) in the rolling shutter camera 25a according to the scanning speed of the spot light and the diameter of the spot light image formed in the CMOS sensor 251 of the rolling shutter camera 25a. By virtue of this, the rolling shutter camera 25a is able to reliably detect the spot light image.

### Fifth Embodiment

Next, a fifth embodiment will be explained. The fifth embodiment is a modification of the fourth embodiment, changing the exposure timing of the rolling shutter camera 25a according to the scanning speed of the spot light.

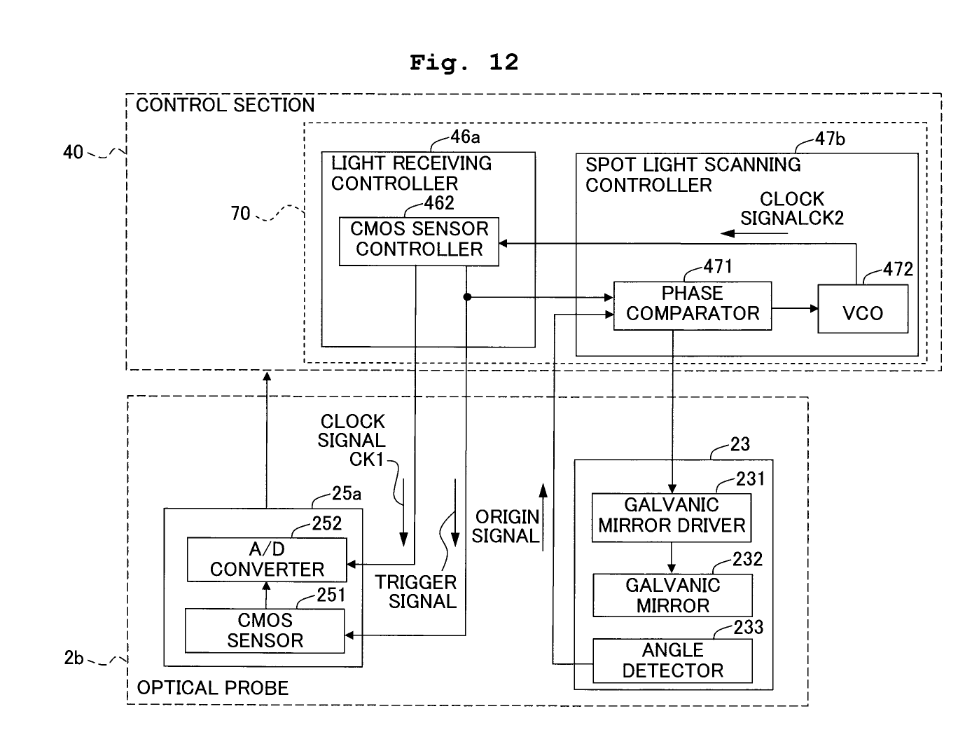

FIG. 12 is a block diagram outlining a configuration of the control section 40 and the optical probe 2b in accordance with the fifth embodiment. Further, FIG. 12 only illustrates the constituents necessary for explaining the fifth embodiment; the others are identical to those in each of the previously shown figures. In this figure, a voltage control oscillator (VCO) 472 is added to a spot light scanning controller 47b with the configuration of FIG. 9.

Based on the comparison result (voltage) of the phase comparator 471, the VCO 472 changes the frequency of the clock signal CK2 so that the phase of the origin signal consist with the phase of the trigger signal. Further, the VCO 472 supplies the CMOS sensor controller 462 with the clock signal CK2 with the changed frequency.

Based on the clock signal CK2 supplied from the VCO 472, the CMOS sensor controller 462 generates the clock signal CK1 and supplies the CMOS sensor 251 with the generated clock signal CK1. That is, according to the scanning speed of the spot light due to the scanner 23, the exposure timing of the rolling shutter camera 25a is changed and the frequency of the clock signal CK1 is changed. That is to say, the ROI selection processor 70 (the spot light scanning controller 47b) changes the exposure timing of the rolling shutter camera 25a according to the scanning speed of the spot light.

By virtue of this, the output timing of the origin signal is synchronized with the output timing of the trigger signal, and thereby the scanning start timing of the spot light consists with the exposure start timing of the rolling shutter camera 25a. Further, the scanning period of the spot light becomes equal to the period (the time width) necessary for the rolling shutter camera 25a to expose one picture. As a result, the spot light scanning controller 47b changes the angle of the galvanic mirror 232 to correspond to the detection line region (the exposure region) of the rolling shutter camera 25a.

In the above manner, in the fifth embodiment, the spot light image can be detected with the detection line region (ROI) corresponding to the irradiation direction of the spot light. Therefore, in the same manner as in each of the aforementioned embodiments, the profile measuring apparatus 100 is able to accurately measure the profile of the measuring object 3 without requiring any complicated mechanisms and advanced adjustment operations. Further, when the frequency of the clock signal CK1 is changed, the measuring controller 45 can as well change the radiation intensity of the spot light source unit 20 according to the frequency of the clock signal CK1. That is, with a high frequency for example, because the exposure time becomes short, the measuring controller 45 causes the spot light source unit 20 to increase the radiation intensity to compensate the shortened exposure time.

### Sixth Embodiment

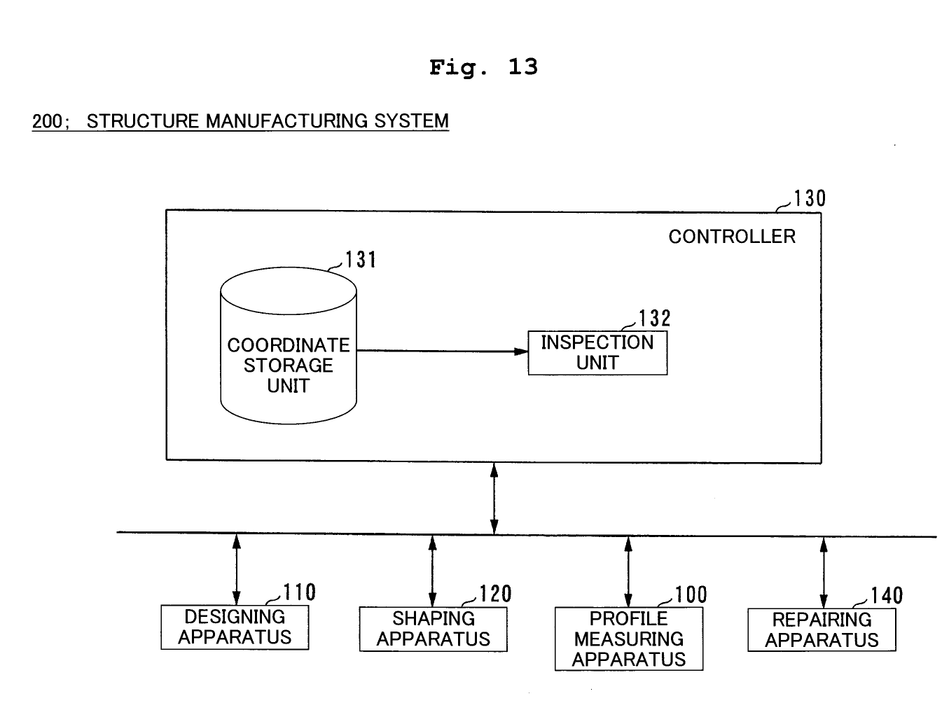

Next, explanations will be made with respect to a manufacturing system of a structure including the profile measuring apparatus 100 described hereinabove. FIG. 13 is a block diagram outlining a configuration of a structure manufacturing system 200. The manufacturing system of the structure includes the aforementioned profile measuring apparatus 100, a designing apparatus 110, a forming apparatus 120, a controller 130 (an inspection apparatus), and a repairing apparatus 140.

The designing apparatus 110 creates design information about the profile of a structure, and sends the created design information to the forming apparatus 120. Further, the designing apparatus 110 stores the created design information into an aftermentioned coordinate storage unit 131 of the controller 130. The design information mentioned here indicates the coordinates of each position of the structure. The forming apparatus 120 forms the structure based on the design information inputted from the designing apparatus 110. The forming process of the forming apparatus 120 includes casting, forging, cutting, or the like. The profile measuring apparatus 100 measures the coordinates of the fabricated structure (the measuring object), and sends information (profile information) indicating the measured coordinates to the controller 130.

The controller 130 includes the coordinate storage unit 131 and an inspection unit 132. The coordinate storage unit 131 stores the design information from the designing apparatus 110 as described hereinbefore. The inspection unit 132 reads out the design information from the coordinate storage unit 131. The inspection unit 132 compares the information (the profile information) indicating the coordinates received from the profile measuring apparatus 100 with the design information read out from the coordinate storage unit 131.

Based on the comparison result, the inspection unit 132 determines whether or not the structure is formed in accordance with the design information. In other words, the inspection unit 132 determines whether or not the fabricated structure is nondefective. When the structure is not formed in accordance with the design information, the inspection unit 132 determines whether or not the structure is repairable. When the structure is repairable, the inspection unit 132 calculates the defective portions and repairing amount or size based on the comparison result, and sends information to the repairing apparatus 140 to indicate the defective portions and the repairing amount.

Based on the information indicating the defective portions and repairing amount received from the controller 130, the repairing apparatus 140 processes the defective portions of the structure.

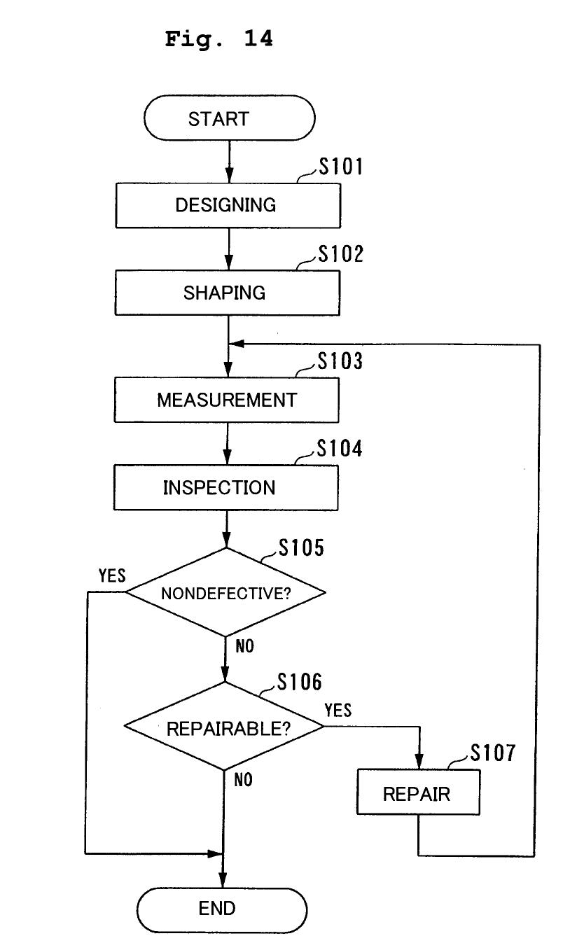

FIG. 14 is a flowchart showing a process flow of the structure manufacturing system 200. First, the designing apparatus 110 creates design information about the profile of a structure (step S101). Next, the forming apparatus 120 forms the structure based on the design information (step S102). Then, by the method as described hereinbefore, the profile measuring apparatus 100 measures the profile of the fabricated structure (step S103). Thereafter, the inspection unit 132 of the controller 130 inspects whether or not the structure is really fabricated in accordance with the design information by comparing the profile information obtained by the profile measuring apparatus 100 with the above design information (step S104).

Next, the inspection unit 132 of the controller 130 determines whether or not the fabricated structure is nondefective (step S105). When the fabricated structure is nondefective (step S105: Yes), then the structure manufacturing system 200 ends the process. On the other hand, when the fabricated structure is defective (step S105: No), the inspection unit 132 of the controller 130 determines whether or not the fabricated structure is repairable (step S106).

When the fabricated structure is repairable (step S106: Yes), the repairing apparatus 140 reprocesses the structure (step S107), and then the process returns to step S103. On the other hand, when the fabricated structure is not repairable (step S106: No), then the structure manufacturing system 200 ends the process. With that, the process of the flowchart is ended.

In the above manner, the profile measuring apparatus 100 of the sixth embodiment is able to correctly measure the coordinates of a structure (the three-dimensional profile of a structure). Thereby, the structure manufacturing system 200 is able to determine whether or not the fabricated structure is nondefective. Further, when the structure is defective, the structure manufacturing system 200 is able to reprocess the structure to repair the same.

Further, the repairing process carried out by the repairing apparatus 140 in the sixth embodiment can as well be replaced by a process for the forming apparatus 120 to carry out the formation process over again. In this case, when the inspection unit 132 of the controller 130 determines that the structure is repairable, the forming apparatus 120 carries out the formation process (forging, cutting and the like) over again. In particular, the forming apparatus 120 cuts the portions of the structure which should have been cut but have not. By virtue of this, the structure manufacturing system 200 is able to correctly fabricate the structure.

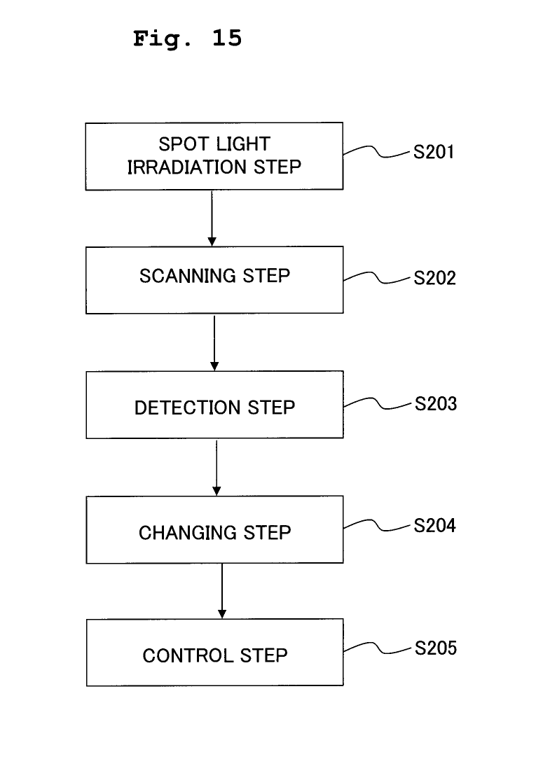

Further, according to the above embodiments, as shown in FIG. 15, the profile measuring apparatus 100 implements such a profile measuring method in accordance with the present teaching as has a spot light irradiation step (S201) of irradiating the measuring object 3 with the spot light; a scanning step (S202) of relatively scanning the surface of the measuring object 3 with the spot light; a detection step (S203) of detecting the spot light image when the spot light irradiates the measuring object 3 from a different direction with the irradiation direction of the spot light irradiating the measuring object 3 by utilizing a plurality of light-receiving pixels; a changing step (S204) of changing positions of light-receiving pixels for obtaining signals utilized to detect a position of the spot light image according to the irradiation direction of the spot light; and a control step (S205) of calculating positional information of the measuring object 3 based on the signals from the light-receiving pixels. Further, the plurality of light-receiving pixels can be aligned in two dimensions, and in the changing step (S204), the light-receiving pixels can be selected for obtaining the signals utilized to detect the position of the image of the spotted pattern from the plurality of light-receiving pixels. By virtue of this, it is possible to accurately measure the profile of the measuring object 3 without requiring any complicated mechanisms and advanced adjustment operations. Further, it is needless to say that the above steps are not necessarily to be carried out in the above order, but can change the sequence as appropriate if desired.

Further, the present teaching should not be limited to any of the above embodiments, but is changeable without departing from the true spirit and scope of the present teaching. For example, in each of the above embodiments, the position computation processor 60 (the controller) can as well calculate the positional information of the measuring object 3 based on the detection result accumulating or integrating the plurality of light-receiving pixels continuous in the vertical direction to the detection lines according to the maximum value of the spot light diameter. That is, the position computation processor 60 can as well read out the detection result integrating the plurality of light-receiving pixels from the light receiving detector 25 or the rolling shutter camera 25a, and calculate the positional information of the measuring object 3 based on this detection result. In this case, because the readout time can be shortened, the profile measuring apparatus 100 is able to shorten the measuring process time. Further, the position computation processor 60 can as well calculate the positional information of the measuring object 3 by integrating the detection result after reading out the detection result of the plurality of light-receiving pixels. Further, the position computation processor 60 can as well selectively utilize these methods according to the measuring range (resolution).

Further, in each of the above embodiments, the ROI selector 461 can determine a detection line region (ROI) to be wider than the diameter of the spot light image, and then calculate the positional information of the measuring object 3 based on the detection result by the detection lines including the brightest position of the spot light image in that detection line region (ROI). For example, the detection line regions (ROI) R1 and R3 as shown in FIG. 5 are determined to be wider than the diameter of the spot light image. In this case, it is possible to reliably capture the spot light image by determining a wider region than the diameter of the spot light image.

Further, in each of the above embodiments, although the scanner 23 is explained as utilizes a galvanic mirror, it can as well scan with the spot light image by moving the measuring object 3 relative to the optical probe 2 without changing the irradiation direction of the spot light. In this case, because the irradiation direction of the spot light (the angle) is invariable, the detection line region is also unchanging. On the other hand, when the measuring object 3 is scanned with the spot light image by changing the irradiation direction of the spot light (the angle), other configurations can be applied as long as these other configurations can change the irradiation direction of the spot light (the angle). For example, the scanner 23 can utilize a MEMS (Micro-Electro Mechanical System) mirror such as a polygon mirror, a DMD (Digital Micro-mirror Device) or the like, or utilize an optical element and the like making use of diffraction phenomenon such as an AOM (Acousto-Optic Modulator) and the like.

Further, in each of the above embodiments, explanations are made for changing the detection line region (ROI) in synchronization with changing the irradiation direction of the spot light relative to the detector, and for causing the scanner 23 to change the irradiation direction of the spot light in synchronization with changing the detection line region (ROI). However, the present teaching should not be limited to these aspects. For example, the profile measuring apparatus 100 can selectively utilize the detection result of the region corresponding to the irradiation direction of the spot light after reading out the detection result of all light-receiving pixels of the light receiving detector 25.

In each of the above embodiments, although the selection table utilized is explained as is generated in advance, it can be periodically remeasured and updated. Further, the profile measuring apparatus 100 can include a function of internally generating the selection table. Further, the table storage memory 51 can store a plurality of selection tables according to the measuring range (the resolution) and measuring conditions. Further, in each of the above embodiments, it is not indispensable that the light-receiving pixels are aligned in two dimensions.

What is claimed is:

1. A profile measuring apparatus which measures a profile of a measuring object, comprising:
an irradiating unit which includes a light source and which is configured to irradiate the measuring object with light from the light source to form a spotted pattern;
a scanner which is arranged in an optical path of the light irradiated from the irradiating unit to relatively scan a surface of the measuring object with the spotted pattern;
a light receiver which includes a plurality of light-receiving pixels aligned to detect an image of the spotted pattern generated by the light irradiating the measuring object from a different direction different from an irradiation direction of the light irradiating the measuring object;
a changing unit which is connected to the scanner and the light receiver to change a position, at which a signal of the light receiver utilized to detect a position of the image of the spotted pattern is obtained, according to the irradiation direction of the light; and
a controller which is connected to the light receiver to calculate positional information of the measuring object based on the signal from the light receiver.

2. The profile measuring apparatus according to claim 1, wherein the light receiver has the plurality of light-receiving pixels arranged in two dimensions, and
the changing unit selects a part of the light-receiving pixels, among the plurality of light-receiving pixels of the light receiver, which obtain the signals utilized to detect the position of the image of the spotted pattern.

3. The profile measuring apparatus according to claim 2, wherein the scanner scans the surface of the measuring object with the spotted pattern by changing the irradiation direction of the light irradiating the measuring object.

4. The profile measuring apparatus according to claim 2, wherein the changing unit selects the part of plurality of light-receiving pixels, from the plurality of light-receiving pixels, which include a light-receiving pixel arranged at a position at which the image of the spotted pattern is formed in the light receiver and which is aligned in a direction different from a displacement direction along which the image of the spotted pattern is displaced under a condition that the light is scanned.

5. The profile measuring apparatus according to claim 2, wherein the changing unit sets a light-receiving pixel group as one detection line aligned in a direction orthogonal to a displacement direction along which the image of the spotted pattern is displaced under a condition that the light is scanned, sets a plurality of detection lines which are arranged at different positions respectively in the displacement direction of the image of the spotted pattern, and selects a detection line region utilized for detection from the plurality of detection lines according to the irradiation direction of the light; and
the controller causes the light receiver to detect the image of the spotted pattern by the selected detection line region.

6. The profile measuring apparatus according to claim 5, wherein the changing unit selects the detection line region based on a selection reference associating the irradiation direction of the light with the detection line region utilized for detection among the plurality of detection lines.

7. The profile measuring apparatus according to claim 6 further comprising a storage unit which is configured to store a selection table,
wherein the selection reference is constructed by the selection table associating the irradiation direction of the light with the utilized detection line region; and
the selection table is generated in advance based on the irradiation direction of the light and the utilized detection lines which are obtained by measuring an object of a predetermined profile.

8. The profile measuring apparatus according to claim 5, wherein the changing unit causes the scanner to change the irradiation direction of the light according to the detection line region utilized for detection among the plurality of detection lines.

9. The profile measuring apparatus according to claim 8, wherein the light receiver is a two-dimensional rolling shutter camera; and
the changing unit determines an exposure time according to a scanning speed of the light and a diameter of the spotted pattern imaged in the light receiver so that the image of the spotted pattern is exposed to the detection line region in the rolling shutter camera.

10. The profile measuring apparatus according to claim 8, wherein the light receiver is a two-dimensional rolling shutter camera; and
the changing unit changes exposure timing of the rolling shutter camera according to a scanning speed of the light.

11. The profile measuring apparatus according to claim 2, wherein the changing unit detects the irradiation direction of the light based on one of a control signal which is used for controlling the scanner, detection information by an angle detector which detects an angle of the light irradiation due to the scanner, and detection information by an irradiation position detector which has a light-receiving element irradiated with light branched from the light to detect an irradiation position of the branched light irradiating the light-receiving element.

12. The profile measuring apparatus according to claim 5, wherein the light source includes an optical portion which projects onto the measuring object the spotted pattern of which diameter vertical to the detection line is narrower than that parallel to the detection line.

13. The profile measuring apparatus according to claim 5, wherein the controller selects a plurality of light-receiving elements which are adjacent to each other in an orthogonal direction orthogonal to the detection line according to a maximum value of diameter of the spotted pattern due to the light, and calculates the positional information of the measuring object based on a detection result of accumulating output values from the plurality of light-receiving elements which are adjacent to each other in the orthogonal direction.

14. The profile measuring apparatus according to claim 5, wherein the changing unit determines the detection line region to be wider than the diameter of the spotted pattern; and
the controller calculates the positional information of the measuring object based on a detection result by the detection line including a light-receiving pixel arranged at the brightest position in the image of the spotted pattern in the detection line region.

15. A method for measuring a profile of a measuring object, comprising:
irradiating the measuring object with light from a light source to form a spotted pattern;
scanning a surface of the measuring object with the spotted pattern relatively;
detecting an image of the spotted pattern generated by the light irradiating the measuring object from a different direction different from an irradiation direction of the light irradiating the measuring object by utilizing a light receiver including a plurality of light-receiving pixels;
changing a position at which a signal of the light receiver utilized to detect a position of the image of the spotted pattern is obtained, according to the irradiation direction of the light; and
calculating positional information of the measuring object based on the signal from the light receiver.

16. The method for measuring the profile according to claim 15, wherein the plurality of light-receiving pixels are arranged in two dimensions, and a part of the light-receiving pixels, among the plurality of light-receiving pixels, which obtain the signals utilized to detect the position of the image of the spotted pattern are selected while changing the positions.

17. The method for measuring the profile according to claim 16, wherein the surface of the measuring object is scanned with the spotted pattern by changing the irradiation direction of the light irradiating the measuring object, while scanning the surface of the measuring object.

18. A method for manufacturing a structure, comprising:
designing design information with respect to a profile of the structure;
forming the structure based on the design information;
measuring the profile of the formed structure by utilizing the method for measuring a profile as defined in claim 15; and
comparing the profile information obtained by the measurement of the profile with the design information.

19. The method for manufacturing the structure according to claim 18 further comprising reprocessing the structure which is carried out based on a result of the comparison between the profile information and the design information.

20. The method for manufacturing the structure according to claim 19, wherein repairing the structure is carried out by forming the structure over again.
